(19) United States
(12) Patent Application Publication
(10) Pub. No.: US 2015/0112821 A1
(43) Pub. Date: Apr. 23, 2015

(54) Budgeting Support at a Transaction Device

(71) Applicant: Bank of America Corporation, Charlotte, NC (US)

(72) Inventor: Michael Giacometti, West Grove, PA (US)

(73) Assignee: Bank of America Corporation, Charlotte, NC (US)

(21) Appl. No.: 14/059,139

(22) Filed: Oct. 21, 2013

(51) Int. Cl. G07F 19/00; G06Q 20/20

(52) U.S. Cl. CPC G07F 19/206; G06Q 40/02; G06Q 20/20
USPC 705/16; 705/39; 705/43

(57) ABSTRACT

Systems, methods, and devices are provided for providing budgeting support at a transaction device. A user may initiate a transaction at the transaction device, and budget categories associated with an account involved in the transaction may be received at the transaction device. The budget categories may be presented to the user at the transaction device during the transaction. Input may be received from the user at the transaction device that identifies one of the budget categories as a selected budget category. The selected budget category may be associated with a transaction record created for the transaction.

### TECHNICAL FIELD

The present disclosure is generally directed toward transaction devices such as automated teller machines (ATMs) and particularly directed towards providing budgeting support at a transaction device.

### BACKGROUND

Individuals have long been interested in tools and techniques to help them manage their personal finances. For example, individuals may utilize various budgeting tools to help them identify and manage their various expenses. While such budgeting tools may be useful to these individuals for general budget management, there remains room for improvement.

Existing budgeting tools may be configured such that users must provide information describing their financial activities after the fact. For example, existing budgeting tools may be configured to receive information regarding spending activities after that spending has already occurred. This may involve entering receipt information into a budgeting tool or downloading account information to the budgeting tool. In either case, the budgeting tool may lack the ability to capture information about the activity as the activity occurs. For example, when an individual withdraws money from an ATM, the individual may subsequently enter information into a budgeting tool identifying the reason for the withdrawal. It is not uncommon, however, for individuals to subsequently forget the reason for the withdrawal before entering the information into the budgeting tool. As a result, existing budgeting tools may miss opportunities to capture relevant information relating to the spending activities and the budget of an individual.

Therefore, a need exists for improved approaches to assisting individuals manage their budgets.

### SUMMARY

The following presents a simplified summary in order to provide a basic understanding of some aspects of the disclosure. The summary is not an extensive overview of the disclosure. It is neither intended to identify key or critical elements nor to delineate the scope of the claimed subject matter. The following summary merely presents some concepts in a simplified form as a prelude to the description below.

A first aspect described herein provides a method of providing budgeting support at a transaction device. A user may initiate a transaction at the transaction device and budget categories associated with an account involved in the transaction may be received at the transaction device. The budget categories may be presented to the user at the transaction device during the transaction. Input may be received from the user at the transaction device that identifies one of the budget categories as a selected budget category. The selected budget category may be associated with a transaction record created for the transaction.

A second aspect described herein provides a transaction device. The transaction device may include a controller configured to control the transaction device while conducting a transaction with a user. The transaction device may also include a display, an input interface, and memory storing computer-readable instructions. When executed by the controller, the instructions may cause the controller to facilitate budgeting support at the transaction device. The transaction machine may retrieve budget categories associated with an account involved in the transaction. The display may present the budget categories to the user during the transaction, and the user may select one or more of the budget categories via the input interface. The selected budget categories may be associated with a transaction record for the transaction conducted at the transaction device.

A third aspect described herein provides a system for providing budget support during a transaction. A data store may store an account record associated with a user and multiple budget category records. A budget management module may be in signal communication with the data store and may be configured to, in operation, associated one or more of the budget category records with the account record in response to receipt of input from the user. A transaction device interface module may also be in signal communication with the data store. The transaction device interface module may be configured to, in operation, provide a transaction device with information identifying the budget category records associated with the account record during a transaction at the transaction device. The transaction device interface module may also be configured to, in operation, receive from the transaction device information indicating a selected budget category record selected by the user at the transaction device during the transaction. The transaction device interface module may further be configured to, in operation, cause the selected budget category record to be associated with a transaction record created for the transaction.

These and additional aspects with be appreciated with the benefit of the detailed description set forth below.

### BRIEF DESCRIPTION OF THE DRAWINGS

The present disclosure is illustrated by way of example and not limited in the accompanying figures in which like reference numerals indicate similar elements.

FIG. 1 is an illustration of example of an implementation of a transaction device.

FIG. 2 is a block diagram of an example of an implementation

FIG. 3 is a flowchart of example method steps for creating a budget.

FIG. 4 is a flowchart of example method steps for associating a budget category with a transaction performed at a transaction device.

FIG. 5 is a flowchart of example method steps for providing budgeting information to a user.

FIG. 6 is a flowchart of example method steps for identifying budgeting information to present to a user.

FIG. 7 is a flowchart of example method steps for applying a rule relating to credit card payment transactions.

FIG. 8 is a block diagram of an example operating environment in which various aspects of the disclosure may be implemented.

FIG. 9 is a block diagram of example workstations and servers that may be used to implement the processes and functions of one or more aspects of the present disclosure.

### DETAILED DESCRIPTION

Aspects of the present disclosure are directed towards providing budgeting support at a transaction device such as, e.g., an automated teller machine (ATM). A user may create a budget having various budget categories and associate the budget and budget categories with one or more accounts. When the user subsequently utilizes a transaction device to perform a transaction, the budget categories for the budget created by the user may be presented to the user. The user may then select one or more of the budget categories to associate with the transaction. In this way, the user may advantageously associate budget categories with distinct transactions contemporaneous with performance of the transactions.

In addition, budgeting information and may be provided to the user based on the budget categories respectively associated with the transactions. The budgeting information may be provided to the user during the transaction or once the transaction is complete. In addition, the budgeting information may be provided to the user through various channels, which will be discussed in further detail below. As used in this disclosure, budgeting information generally refers to any information a user might find useful with respect to how the user budgets and spends money. Providing budgeting information to users may advantageously help users educate themselves about various financial topics and budgeting techniques, which, in turn, may help users improve their financial situations.

Some examples of the various types of budgeting information include definitions and descriptions of financial terms, topics, products, and services; budgeting advice and budgeting techniques; recommendations for products or services that might improve the financial situation of a user; budget utilizations for the budget categories selected by the user; and other types of information a user might find useful with respect to how the user budgets and spends money. Recommendations for products or services may include recommendations for, e.g., various types of bank accounts; various types of investment instruments; various refinancing options; rewards programs or loyalty programs; and other types of recommendations that might improve the financial situation of the user. A respective budget utilization may be associated with each budget category of a budget created by the user. Budget utilization refers to information relating to an estimated expenditure for a budget category and an actual expenditure for the budget category. Budget utilization may indicate, for example, the difference between the estimated expenditure and the actual expenditure for the budget category; a percentage of the estimated expenditure that has been utilized; utilization trends across a multiple timeframes (e.g., weeks, months); and other information related to the estimated or actual expenditure for the budget category. As discussed in further detail below, a budget utilization for a budget category may be determined based on the transactions the budget category is assigned to.

The budgeting information may be provided to the user unsolicited or in response to a request for specific budgeting information. The budgeting information provided to the user may also be based on the budget categories of the budget created by the user; the budget categories associated with transactions performed by the user; the budget utilizations of the budget categories associated with the user; and other factors related to the budget, budget categories, or transactions associated with the user. The budgeting information provided to the user may additionally or alternatively be independent of factors related to the budget, budget categories, or transactions associated with the user.

As described above, a user may create a budget and associate the budget with one or more accounts. Some examples of the various types of accounts a budget may be associated with include a checking account, a savings account, a credit card account, a debit account, an investment account, a loan account, a rewards account, a loyalty program account; and other types of accounts that will be appreciated with the benefit of this disclosure.

As also described above, a user may associate one or more budget categories with a transaction involving an account while performing the transaction at a transaction device. Some examples of transaction devices include automated teller machines (ATMs); point-of-sale (POS) devices; mobile computing devices equipped with a card reader; computing devices configured to access online payment services or money transfer services; and other types of devices configured to perform transactions. Aspects of the disclosure set forth below are described in the context of transactions performed at ATMs. It will be appreciated, however, that one of more of the aspects described below may be implemented at additional or alternative types of transaction devices.

A user may associate budget categories with various types of transactions. Some examples of transactions include a deposit transaction, a withdrawal transaction, a transfer transaction, a payment transaction, a purchase transaction, and other types of transactions that may be performed at a transaction device.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging. In addition, “set” as used in this description refers to a collection that may include one element or more than one element. Moreover, aspects of the disclosure may be implemented in non-transitory computer-readable media having instructions stored thereon that, when executed by a processor, cause the processor to perform various steps described in further detail below. As used in this description, non-transitory computer-readable media refers to all computer-readable media with the sole exception being a transitory propagating signal.

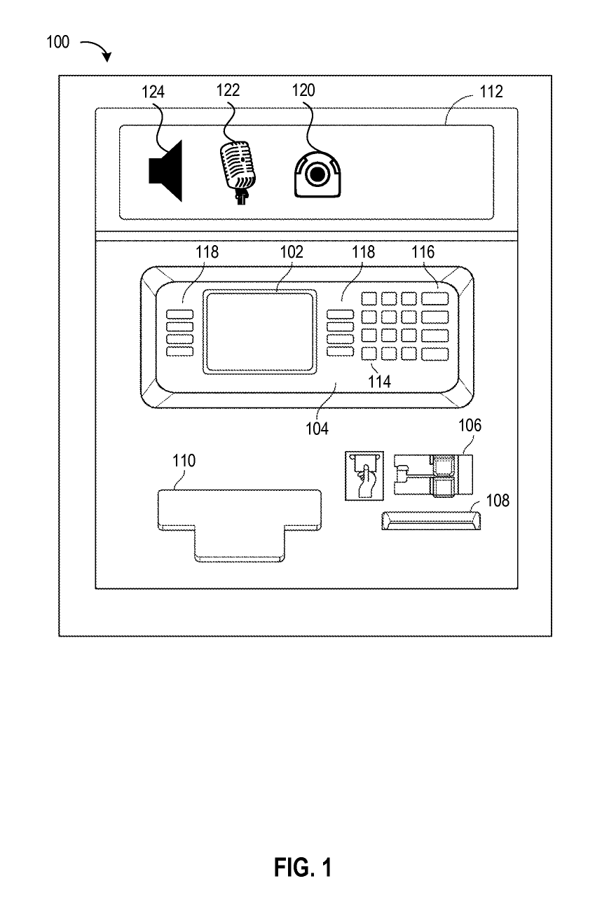

Referring now to FIG. 1, an example of an implementation of a transaction device 100 is shown. In this example, the transaction device 100 is an automated teller machine (ATM). Accordingly, the ATM 100, in this example, includes a display 102, a keypad 104, a card reader port 106, an item acceptor 108, an item dispenser 110; a security screen 112. Not all of the components of the ATM 100 are illustrated in FIG. 1. The ATM 100 may include additional or alternative components that will be appreciated by those skilled in the art.

The display 102 may be, e.g., a monitor that exchanges visual information with a user. The display 102 may also receive input from the user via a touch screen of the display. As discussed in further detail below, a user at the ATM may initiate a video chat session with a remote teller, and the display 102 of the ATM 100 may present the video of the remote teller during the video chat session. The keypad 104 may include alphanumeric keys 114 for the user to enter numerical and textual data. The keypad 104 may also include control keys 116. In some embodiments, the control keys 116 may be used to communicate control information, such as instructions, to the ATM 100. The keypad 104 may also include soft keys 118. The soft keys 118 may have functions that are dictated by programming and are presented to the user as information presented at the display 102.

The card reader port 106 may be the front end of any suitable card reader. The card reader may read magnetically encoded information on transaction instruments such as bank cards. For other types of transaction devices, other examples of cards include credit cards, debit cards, rewards cards, loyalty program cards, and other types of cards associated with an account. The transaction instrument may also be a chip, a radio-frequency identification (RFID) tag, a smart card, a personal digital assistant (PDA), a mobile phone or any other device suitable to identify and authenticate the user. In some embodiments, a transaction device such as the ATM 100 may additionally or alternatively include a contactless chip reader, a wireless transceiver, a near field communications (NFC) transceiver, a barcode reader, or any other receiver or interface suitable for exchanging or receiving information from a transaction instrument or other electronic instrument. The information exchanged or received may include user identification information, user authentication information, transaction information, or any other information related to a transaction performed at a transaction devices such as the ATM 100.

In some embodiments, a transaction device such as the ATM 100 may include a biometric sensor configured to identify a user based on a feature, such as a biometric feature, of the user. For example, the biometric sensor may be configured to identify the user based on all or part of a face, a fingerprint, an iris, a retina, a hand or any other biometric feature suitable to identify the user. The biometric sensor may also identify the user based on a behavioral feature such as a signature, a voice, a gait, or any other behavioral feature suitable to identify the user.

The item acceptor 108 may accept various types of items such as, for example, documents. The item acceptor 108 may, for example, accept envelopes, deposit forms, bills, checks, or any other documents related to a transaction performed at the ATM 100. In some embodiments, the item acceptor 108 may feed into a scanner that digitizes the documents for image-based transaction processing. In some example implementations, a transaction device may include one item acceptor that can accept multiple types of media, while in other example implementations, a transaction device may include multiple item acceptors that respectively accept distinct types of media. When the transaction device is an ATM, for example, the ATM may include one item acceptor that accepts, e.g., both checks and cash; or the ATM may include two item acceptors, one item acceptor that accepts checks and another item acceptor that accepts cash. The item dispenser 110 may dispense items from the ATM 100. In some example embodiments, the item dispenser 110 may be a bill dispenser that dispenses bills from the ATM 100.

The security screen 112 may visually hide a surveillance device such as a camera 120. The camera 120 may provide video information about individuals that are present near the ATM 100 and the conditions of the surrounding environment. The camera 120 may also be used to obtain video of a user at the ATM 100 during a video chat session with a remote teller. The ATM 100 may be configured to provide the video obtained of the user via the camera 120 to a system operated by the remote teller during the video chat session. As mentioned above, the display 102 may present to the user video captured of the remote teller during the video chat session. The security screen may also visually hide an audio input device such as a microphone 122 and an audio output device such as a speaker 124. During the video chat session, the microphone 122 may obtain audio from the user, and the ATM 100 may provide the audio to the system operated by the remote teller. The ATM 100 may also receive audio from the system operated by the remote teller and present the received audio at the speaker 124 during the video chat session.

A user may activate an ATM session by providing user identification information—e.g., by inserting a bank card into the card reader port 106—and providing user authentication information—e.g., by typing in a personal identification number (PIN) at the keypad 104. Upon verification of the PIN, the display 102 of the ATM 100 may present various ATM transaction options. Upon selection of one of the transaction options, the ATM 100 may initiate the selected transaction. As described in further detail below, the ATM 100 may retrieve the budget categories of the budget created by the user and present the budget categories at the display 102 during the transaction. The user may select one or more of the budget categories to associate with the transaction, and the ATM 100 may cause the selected budget categories to be associated with a record of the transaction.

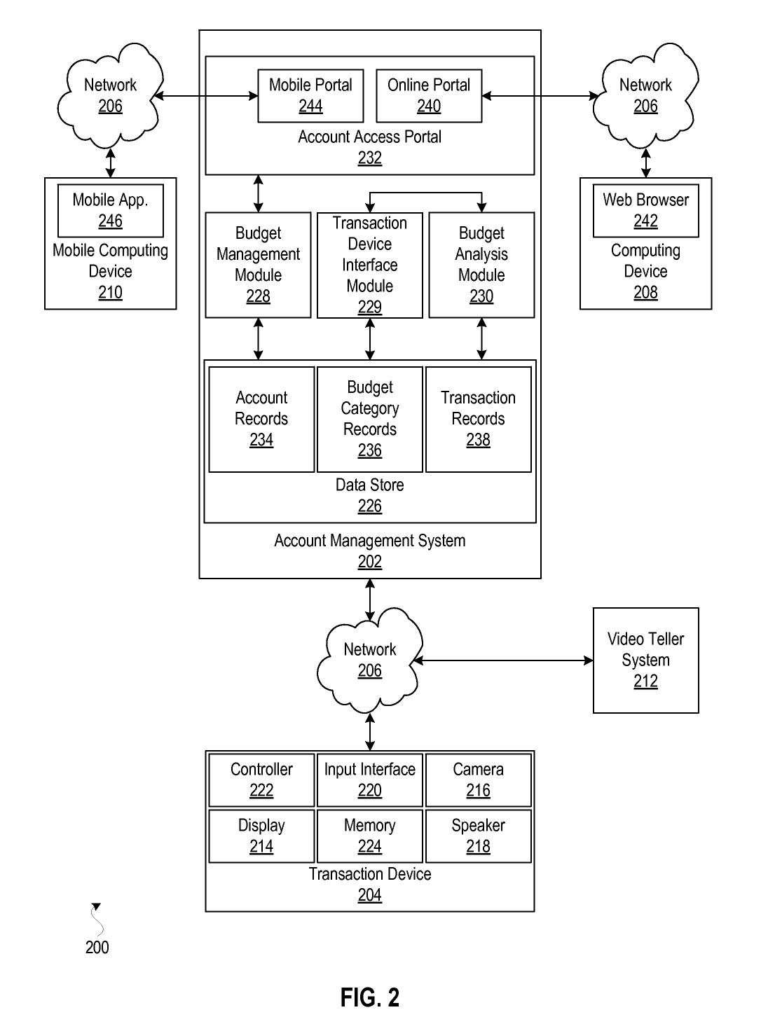

Referring now to FIG. 2, an example of an implementation of a system 200 for providing budgeting information is shown. The system 200, in this example, includes an account management system 202 that is in signal communication with a transaction device 204 via a network 206. The network may be a wired or wireless computer network, or the network may be a combination of multiple wired or wireless computer networks, e.g., the Internet. Although only one transaction device 204 is depicted in FIG. 2, the account system may be in signal communication with multiple transaction devices via the network 206. The account management system 202 may also be in signal communication with multiple computing devices via the network 206 such as the computing device 208 and the mobile computing device 210 shown by way of example in FIG. 2. The transaction device 204 may also be in signal communication with a video teller system 212.

The transaction device 204 may be similar to the transaction device 100 described above with reference to FIG. 1. Accordingly, the transaction device 204 may be an ATM that includes a display 214 similar to display 102, a camera 216 similar to camera 120, and a speaker 218 similar to speaker 124. The transaction device 204 may also include an input interface 220 that receives input from the user at the transaction device. The input interface 220 may be, e.g., keys similar to the alphanumeric keys 114, control keys 116, or soft keys 118 described above with reference to FIG. 1. The input interface 220 may also be, e.g., a microphone similar to the microphone 122 described above with reference to FIG. 1. It will be appreciated that the transaction device 204 may include various combinations of different types of input interfaces.

As seen in FIG. 2, a transaction device such as transaction device 204 may include a controller 222 and a memory 224. The controller 222 may be configured to control the various components of the transaction device 204 when conducting a transaction with a user. The controller 222 may be, e.g., one or more central processing units (CPUs) that receive information from the keypad, card reader port, item acceptor, item dispenser, and other components of a transaction device that will be appreciated by those skilled in the art. The controller 222 may control customer input/output, the item dispensing processes—which may include initialization, actuation, dispensing, receipt printing and dispensing—transaction channel communications, and other transaction-related processes. The memory 224 may be store computer-readable instructions that, when executed by the controller 222, cause the controller to perform various steps related to conducting a transaction with the user at the transaction device, display budget categories to the user, associate one or more selected budget categories with a record of the transaction, and cause budgeting information to be provided to the user. These example steps will be described in further detail below.

The account management system 202 may maintain the account information, budget information, and transaction information associated with a user. The account management system 202, in this example, includes a data store 226, a budget management module 228, a transaction device interface module, a budget analysis module 230, and an account access portal 232. The account management system 202 may include additional or alternative components that will be appreciated with the benefit of this disclosure. An account management system such as the account management system 202 may be part of a banking system that stores information regarding one or more bank accounts for a user, information regarding various transactions performed by the user involving those bank accounts, and information regarding various budget categories associated with those bank accounts and those transactions. The banking system and its account management system may be maintained, e.g., by a banking entity. As discussed further below, various individuals associated with the entity that maintains the account management system 202 may selectively configure various aspects of the account management system according to the goals, objectives, and interests of the entity.

The data store 226 may be, e.g., a database implementing a data model that defines various entities, attributes, and relationships for accounts, transactions, budgets, and budget categories. Accordingly, the data store 226 may store various records such as, e.g., account records 234, budget category records 236, and transaction records 238. The data store 226 may store additional types of records that will be appreciated with the benefit of this disclosure. A database management system (not shown) may facilitate the storage of information at and the retrieval of information from the data store 226. Accordingly, the database management system may create and modify account records 234, budget category records 236, and transaction records 238 in response to input received from a user, in response to a transaction performed at the transaction device 204, or in response to other account-related activities that will be appreciated with the benefit of this disclosure.

The data model of the data store 226 may define an account record 234 to include various account-related attributes such as, for example, an account number, an account type (e.g., checking, savings, credit card), and an account balance. The data model of the data store 226 may define a budget category record 236 to include various budget-related attributes such as, for example, a budget category name, a budget category description, an estimated expenditure amount, and an actual expenditure amount. The data model of the data store 226 may define a transaction record to include various transaction-related attributes such as, for example, a transaction type (e.g., deposit, withdrawal, payment, transfer), a transaction amount, and a transaction date and time. The data model of the data store 226 may define other account-related attributes, budget-related attributes, and transaction-related attributes that will be appreciated with the benefit of this disclosure.

An account and a transaction may be associated with one or more budget categories. An account may also be associated with one or more transactions. The data model of the data store may thus define relationships between the account records 234, the budget category records 236, and the transaction records 238 in order to indicate the relationships between accounts, budget categories, and transactions. A budget may refer to a set of budget categories, and an account may be associated with multiple budgets. Accordingly, the data store 226 may also store budget records (not shown), and the data model of the data store may define a relationship between budget records and budget category records. In this way, a user may create multiple budgets having different sets of budget categories and associate the budgets with respective accounts of the user.

A user may access the account management system 202 via the account access portal of the account management system. The user may access the account management system 202 using a computing device such as computing device 208, which may be, e.g., a desktop computer, a laptop computer, a mobile computing device, a smart television, a video game system, or other types of computing devices configured to communicate over a network. The user may also access the account management system 202 using a mobile computing device configured for wireless communication such as mobile computing device 210 which may be, e.g., a tablet computing device, a palmtop computing device, a smart cellular telephone, and other types of mobile computing devices configured to wirelessly communication over a network.

The account access portal 232 of the account management system 202 may thus include an online portal 240 that provides access to the account management system from the computing device 208 through, e.g., a web browser 242 residing at the computing device. The account access portal 232 may also include a mobile portal 244 that provides access to the account management system from the mobile computing device 210 through, e.g., a mobile application 246 residing at the mobile computing device.

Communications used to access to the account management system 202 through the online portal 240 or the mobile portal 244 may include, e.g., HyperText Transfer Protocol (HTTP) requests. The communications may be sent via the network 206, which may include one or more wireless networks (e.g., a cellular network), wired networks (e.g., the Internet), or a combination of wired or wireless networks. The online portal 240 may provide access to the account management system 302 over the Internet and may thus include one or more web pages and web services. The mobile portal 244 may provide access to the account management system 202 via the mobile application 246 (which may be referred to as a “mobile app” or “app”) installed at the mobile computing device 210.

The budget management module 228 may be configured to facilitate viewing, creation, and modification of information related to accounts, budget categories, and transactions associated with a user. Accordingly, the budget management module 228 may be in signal communication with the data store 226 as shown by way of example in FIG. 2. Additionally, the account access portal 232 may be in signal communication with the budget management module 228 and the data store 226 to enable the user to view, create, and modify information related to accounts, budget categories, and transactions from, e.g., the computing device 208 or the mobile computing device 210. The user may, for example, login to the account management system 202 through the account access portal 232 in order to gain access to the accounts of the user. Having been identified and authenticated during the login procedure, the user may utilize the budget management module 228 to associate budget categories to an account. Using the budget management module 228, a user may create new budgets and associate those budgets with one or more accounts, create or select budget categories for the budgets, or modify existing budgets or budget categories.

In some example implementations, the budget management module 228 may provide the user with predefined budgets (e.g. a “standard budget”) or predefined budget categories the user may select from. In some example implementations, the budget management module 228 may be configured to allow the user to define new budget categories (e.g., “user-defined budget categories”). Accordingly, a user may selectively associate predefined budget categories as well as user-defined budget categories with an account of the user. Budget categories may include categories that represent a source of income for the user or an expense to the user. Some examples of budget categories that represent a source of income for the user include budget categories such as “paycheck,” “bonus,” “gift,” “tax refund,” “investment,” and other types of income sources. Some examples of budget categories that represent an expense for the user include budget categories such as “rent,” “mortgage,” “car loan,” “grocery,” “utilities,” “insurance,” and other types of expenses.

Using the budget management module 228, a user may also modify various attributes of a predefined budget category or a user-defined budget category. The user may, for example, identify whether a budget category represents a source of income for the user or an expense to the user. For budget categories that represent an expense, the user may set an estimated expenditure for the budget category, e.g., “$200/month” for a “grocery” budget category. Using the budget management module 228, the user may also view budget utilizations for the budget categories associated with an account.

The transaction device interface module 229 may facilitate communications between the account management system and a transaction device such as the transaction device 204, e.g., via the network 206. The communications between the transaction device interface module 229 and the transaction device 204 may be similar to the communications between the account access portal 232 and the computing devices 208 and 210.

The transaction device interface module 229 may be configured to provide the transaction device with information identifying the budget category records associated with an account. During a transaction, for example, the transaction device 204 may identify and authenticate a user and identify one or more accounts associated with the user. The transaction device 204 may then submit a request to the transaction device interface module 229 requesting the budget categories associated with one or more of the accounts for the user. In response to the request, the transaction device interface module 229 may query the data store 226 for the set of budget category records 236 associated with one or more of the accounts identified in the request. Having retrieved the set of budget category records, the transaction device interface module 229 may send information identifying the set of budget category records to the transaction device 204.

The transaction device interface module 229 may also be configured to receive information from the transaction device 204 that indicates a budget category selected by the user to be associated with a transaction performed at the transaction device. In response to receipt of the information, the transaction device interface module 229 may be configured to cause the selected budget category to be associated with the transaction record created for the transaction. The transaction device interface module 229 may additionally be configured to provide budgeting information to the transaction device 204 for presentation to the user. As described in further detail below, the budget analysis module 230 may identify the budgeting information to be provided to the user. Accordingly, the transaction device interface module 229 may also be in signal communication with the budget analysis module as shown by way of example in FIG. 2.

The budget analysis module 230 may be configured to analyze the account information, budget category information, and transaction information associated with an account of a user. Based on the analysis of the account information, budget category information, and transaction information, the budget analysis module 230 may identify budgeting information to provide to the user. The budget analysis module 230 may identify budgeting information to provide to the user based on the budget categories of the budget created by the user; based on the transactions performed by the user; based on the budget utilizations of the budget categories; and based on other factors related to an analysis of the account, budget category, and transaction information that will be appreciated with the benefit of this disclosure. Having identified the budgeting information to provide to the user, the budget analysis module 230 may, in some example implementations, provide the budgeting information to the transaction device interface module 229, which may in turn provide the budgeting information to the transaction device 204 for presentation to the user.

Budgeting information based on the budget categories of a budget created by the user may include the following examples. In one example, the budget analysis module 230 may analyze the budget categories of a budget created by a user and determine that the budget categories include a “grocery” budget category and a “gas” budget category. Based on the analysis of the budget categories, in this example, the budget analysis module 230 may identify one or more loyalty programs and recommend the loyalty programs to the user. The loyalty programs may offer discounts that might offer savings on purchases in these budget categories. As another example, the budget analysis module 230 may analyze the budget categories of a budget created by the user and determine that the budget categories include multiple loan categories. Based on the analysis of the budget categories, in this other example, the budget analysis module 230 may identify one or more loan consolidation programs or refinancing options and recommend the loan consolidation programs and refinancing options to the user. The loan consolidation programs may reduce the amount of interest paid over the life of the loan. Additional examples will be appreciated with the benefit of this disclosure.

The budget analysis module may also identify budgeting information to provide the user based on an analysis of the budget utilization information. In one example, the budget analysis module 230 may analyze the transaction information associated with a budget category and determine that the actual expenditure for that budget category tends to exceed the estimated expenditure for the budget category. Based on the analysis of the transaction information, in this example, the budget analysis module 230 may identify various budgeting techniques that might help the user keep the actual expenditure for the budget category at or below the estimated expenditure. In another example, the budget analysis module 230 may analyze the transaction information associated with a budget category and determine that the actual expenditure for that budget category tends to be below the estimated expenditure for the budget category. Based on the analysis of the transaction information, the budget analysis module 230, in this other example, may identify one or more investment options the user may invest the excess budgeted amount not currently utilized. Additional examples will again be appreciated with the benefit of this disclosure.

The budget analysis module 230 may also initiate other types of actions based on an analysis of the account, budget category, and transaction information. The budget analysis module 230 may, for example, be configured to analyze account, budget category, and transaction information with respect to various rules created by individuals associated with the account management system 202. As noted above, the account management system 202 may be selectively configured by individuals associated with the account management system 202, which may include creating and configuring various rules to apply when analyzing the account, budget category, and transaction information. Individuals may create and configure rules via an interface (not shown) of the account management system 202 using a computing device such as a computing device similar to the computing device 208. The rules may be stored, for example, at the data store 226 of the account management system 202.

A rule may comprise a trigger and an action to perform when the trigger is satisfied. The trigger may relate to the occurrence of various events involving an account, budget category, or transaction. Some examples of triggers include creating a new budget for an account; associating a particular budget category with an account; setting an estimated expenditure within a predetermined range; performing a particular type of transaction; associating a particular budget category with a transaction; performing a transaction that causes the actual expenditure of a budget category to exceed the estimated expenditure; performing a transaction associated with a particular budget category involving an amount that exceeds a predetermined amount threshold; and other types of triggers that will be appreciated with the benefit of this disclosure. When an event occurs, the budget analysis module 230 may retrieve one or more rules and determine whether the event satisfies the trigger of the rules. If the trigger of a rule is satisfied, the budget analysis module 230 may perform or initiate performance of the corresponding action of the rule.

An action may specify one or more steps to perform in response to a determination that the trigger is satisfied. Some examples of actions include retrieving budgeting information to provide to a user; initiating a communication to the user such an email message, text message, post mail message, telephone call, dialog box, and so forth; modifying one or more metrics associated with the user, an account of the user, and so forth; and other types of actions that will be appreciated with the benefit of this disclosure.

In one particular example, a bank may seek to more closely evaluate the banking activities of individuals that only make the minimum payments on their credit card accounts. A budgeting support associate at a budget management department of the bank may therefore create a rule defining a trigger that is satisfied when a user performs a credit card payment transaction that is below a predetermined payment amount threshold (e.g., $50.00). The budget support associate may also define an action for the rule that notifies one or more budget support associates at the bank when the trigger is satisfied, and a budget support associate that receives the alert may more closely evaluate the banking activities of the user in order to identify any budgeting information (such as budgeting techniques) to recommend to the user. In this way, a bank may proactively assist users in managing their budgets to improve their respective financial situations.

In another particular example, the marketing department of a bank may desire to be alerted when a user performs a transaction associated with a particular budget category that exceeds a particular amount. An individual of the marketing department may therefore create a rule defining a trigger that is satisfied when a user performs a particular type of transaction (e.g., a withdrawal transaction) that is associated with a particular budget category (e.g., a “grocery” budget category) and that exceeds a predetermined amount (e.g., $300.00). The individual may also define an action for the rule that initiates creation of an alert with the transaction details and sends the alert to the individual in the marketing department. Having received the alert, the individual may review the transaction details and determine how to respond. For example, the transaction details may indicate that the user performed a withdrawal transaction for $500.00 and associated the withdrawal transaction with a “grocery” budget category. The individual in the marketing department may thus determine to issue the user an invitation to a membership-only retail warehouse club, which may provide savings for the grocery budget of the user. Stated differently, an action may be defined that simply provides the raw data corresponding to the transaction to the individual, and the individual may determine if and how to respond further. Other examples will be appreciated with the benefit of this disclosure.

The video teller system 212 may be a system that allows a user at the transaction device 204 to engage with a live remote teller during a video chat session. Accordingly, video of the remote teller may be obtained at the video teller system 212 (e.g., via a camera), and the video of the remote teller may be transmitted to the transaction device 204 for presentation to the user (e.g., at the display 214 of the transaction device). The video teller system 212 may similarly obtain audio of the remote teller during the video chat sessions and transmit the audio to the transaction device 204 for presentation to the user (e.g., at the speaker 218 of the transaction device). The remote teller may also provide budgeting information to the user during the video chat session. As an example, the remote teller may answer questions the user may have with respect to, e.g., various financial or budgeting topics. To assist the remote teller in determining what types of budgeting information to provide to the user, the account management system 202 may provide the video teller system with account information, budget information, and transaction information associated with the user. In this way, the remote teller may advantageously determine what types of budgeting information the user might be most interested in and tailor the budgeting information provided to the user.

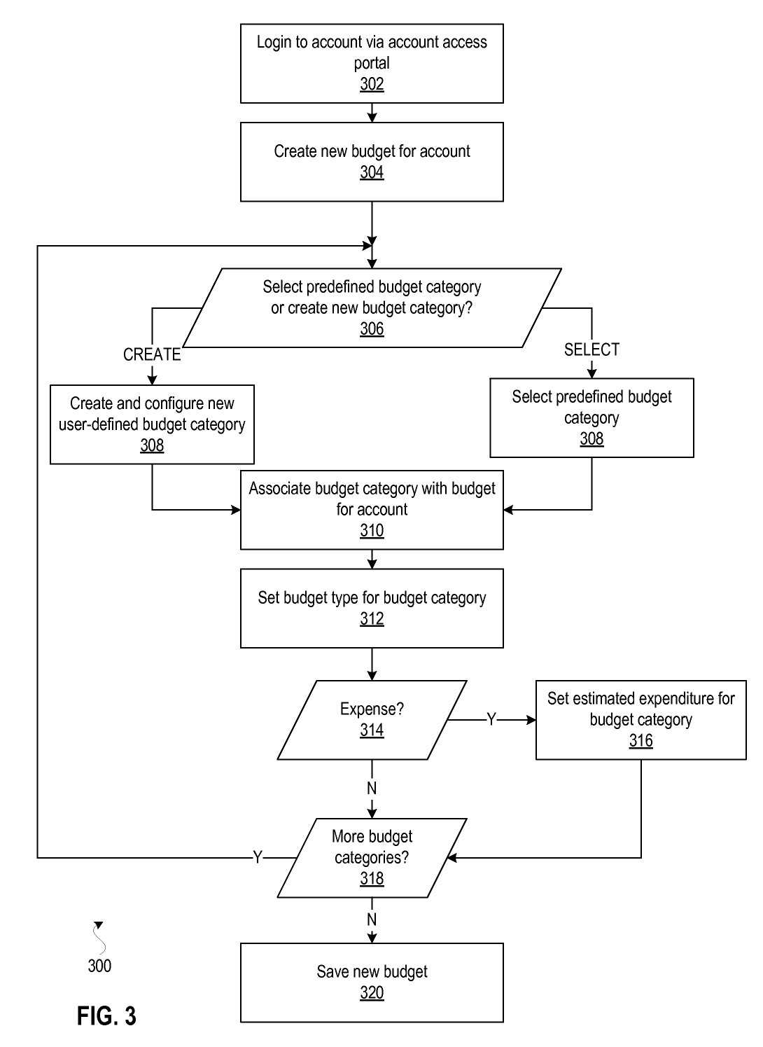

Referring now to FIG. 3, a flowchart 300 of example method steps for creating a budget is shown. A user may login to an account via an account access portal (block 302). Once logged in, the user may select an account and create a new budget for the account (block 304) using, e.g., a budget management module. Having created the new budget, the user may associate one or more budget categories with the budget for the account. As noted above, the user may select a predefined budget category or create a user-defined budget category. If the user decides to select a predefined budget category (block 306:SELECT), then the user may select a predefined budget category (block 308) from, e.g., a list of predefined budget categories and associate the selected budget category with the budget for the account (block 310). If the user decides to create a user-defined budget category (block 306:CREATE), then the user may create and configure a new budget category (block 308), e.g., by setting the name of the budget category. The user may likewise associate the newly created user-defined budget category with the budget created for the account (block 310). A user may associate both predefined and user-defined budget category with the budget for the account. Through their association with the budget, the budget categories may also be associated with the account. Budgets and budget categories may be implemented as budget records and budget category records as described above.

Having associated a budget category with the budget for the account, the user may set the budget type for the budget category (block 312), e.g., whether the budget category represents a source of income or an expense. If the budget category represents an expense for the user (block 314:Y), then the user may set an estimated expenditure for the budget category (block 316). If the budget category does not represent an expense (block 314:N), or once the user sets the estimated expenditure for the budget category, the user may determine whether to associated additional budget categories with the budget for the account (block 318). If the user desires to associate additional budget categories with the account (block 318:Y), then the user may select or create another budget category and repeat steps 306-318. If the user has finished associating budget categories with the budget for the account (block 318:N), the user may save the budget (block 320). The budget and budget categories may be saved, e.g., at a data store of an account management system as described above.

A user may create the budget using a computing device or a mobile computing device such as those described above with reference to FIG. 2. In some example implementations, the transaction device may be configured to allow the user to create a budget at the transaction device itself. For example, the transaction device may allow the user to create a new budget based on a “standard budget” with a set of predefined budget categories. The user may then subsequently modify the budget or budget categories using a computing device or mobile computing device via an online portal or mobile portal of an account access portal as described above. The account management system may provide the budget categories associated with an account to a transaction device, e.g., in response to receipt of a request from the transaction device. It will be appreciated that various steps illustrated in FIG. 3 may be performed to modify an existing budget and existing budget categories.

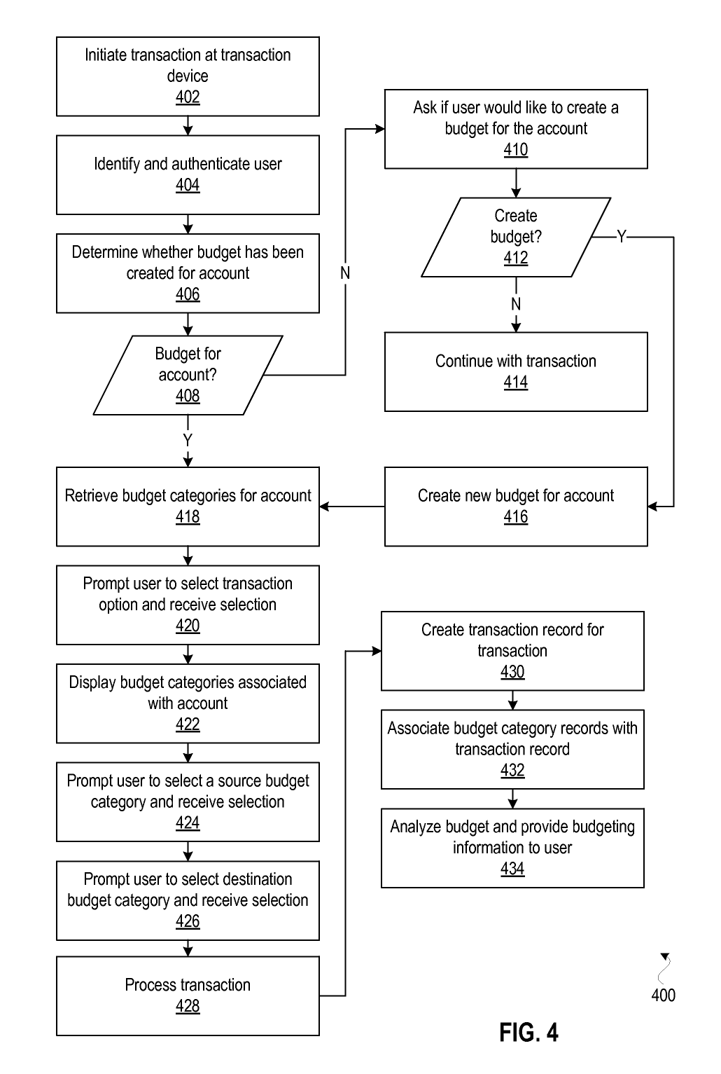

In FIG. 4, a flowchart 400 of example method steps for associating a budget category with a transaction performed at a transaction device is shown. A user may initiate a transaction at a transaction device (block 402), and the transaction device may identify and authenticate the user (block 404), e.g., via a card and PIN. Having identified and authenticated the user, the transaction device may retrieve information related to one or more accounts associated with the user and determine whether a budget has been created for at least one of the accounts (block 406). As described above, the transaction device may submit a request for the budget categories associated with an account of the user to a transaction device interface module of an account management system and receive the budget categories from the transaction device interface module in response to receipt of the request. If a budget has not yet been created for the account (block 408:N), then the transaction device may ask the user if the user would like to create a budget for the account (block 410). If the user declines to create a budget for the account (block 412:N), then the transaction device may continue the transaction as normal (block 414). If the user agrees to create a budget for the account (block 412:Y), then the user may create a new budget for the account (block 416), e.g., at the transaction device as described above. Information related to the budget created at the transaction device may be provided to the account management system via the transaction device interface module.

If a budget has been created for the account (block 408:Y), or after the user creates a budget for the account, the transaction device may retrieve the budget categories associated with the account (block 418), e.g., via the transaction device interface module. During the transaction, the transaction device may prompt the user to select a transaction option and receive input from the user indicating a selected transaction option (block 420), e.g., deposit, withdrawal, payment, transfer, and so forth. After receiving the selection of the transaction option, the transaction device display the budget categories associated with the account (block 422) and prompt the user to select at least one budget category to associate with the transaction. In this example, the transaction device may prompt the user to select a source budget category (block 424) as well as a destination budget category (block 426) to associate with the transaction. The source budget category may, e.g., represent a source of income for the user, and the destination budget category may, e.g., represent an expense of the user. Having received the selections of the one or more budget categories, the transaction device may process the transaction (block 428) and initiate creation of a transaction record corresponding to the transaction (block 430). The account management system may create the transaction record for the transaction and associate the budget category records for the selected budget categories with the transaction record (block 432). As described above, the transaction device may provide information indicating the selected budget categories to an account management system via a transaction device interface module. The budget analysis module of the account management system may subsequently analyze the transaction record (block 434) as described above.

It will be appreciated that some of the steps described above may be optional or performed in an alternative sequence. As an example, where the transaction is a purchase transaction at a POS device, the POS device may identify the user via, e.g., a loyalty program card and need not authenticate the user. In another example, the user may only select a destination budget category rather than both a source budget category and a destination budget category. In a further example, the transaction device may prompt the user to select one or more budget categories to associate with the transaction after the transaction is complete rather than before. Other examples of alternative implementations will be appreciated with the benefit of this disclosure.

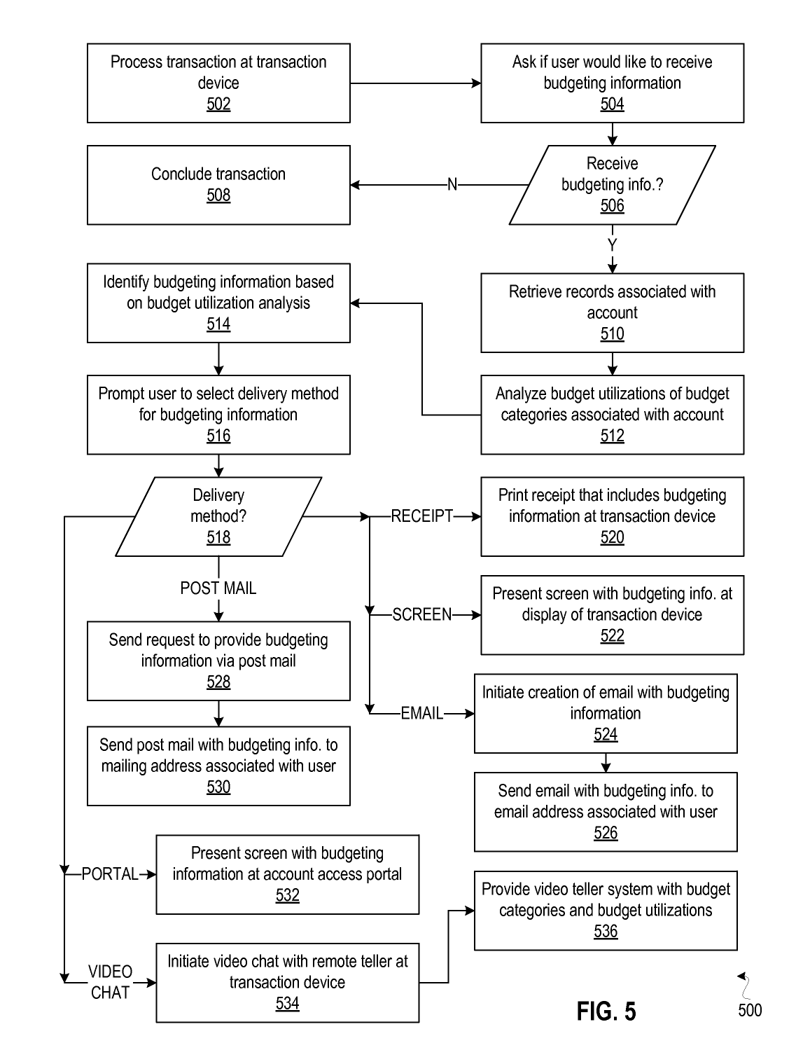

With reference to FIG. 5, a flowchart 500 of example method steps for providing budgeting information to a user is shown. As described above, a transaction device may process a transaction for a user (block 502). During or after the transaction, the transaction device may ask the user if the user would like to receive budgeting information (block 504). If the user declines the offer of budgeting information (block 506:N), then the transaction device may conclude the transaction (block 508). If the user accepts the offer to receive budgeting information (block 506:Y), then the transaction device may initiate retrieval of the transaction records and budget category records associated with the account (block 510), e.g., by transmitting a request to the transaction device interface module of an account management system. In this example, the budget analysis module at the account management system may retrieve and analyze the transaction records and budget category records for the account to assess the budget utilizations of the budget categories (block 512). Also in this example, the budget analysis module may identify budgeting information to provide to the user based on the analysis of the budget utilizations (block 514). Having identified the budgeting information to provide to the user, the transaction device may prompt the user to select a delivery method to receive the budgeting information (block 516). If the user selects a delivery method that involves presenting the budgeting information at the transaction device, the budget analysis module may provide the identified budgeting information to the transaction device interface module for transmission to the transaction device.

As noted above, various channels may be employed to deliver the budgeting information to the user. Some examples of deliver options include an email or post mail sent to the user; a screen displayed at the transaction device or the account management portal; a receipt printed at a printer of the transaction device; or a remote teller during a video chat session. If the user selects to receive the budgeting information via a receipt (block 518:RECEIPT), then the transaction device may print a receipt that includes the budgeting information (block 520). If the user selects to receive the budgeting information via a screen presented at the transaction device (block 518:SCREEN), then the transaction device may present at its display a screen including the budgeting information (block 522). If the user selects to receive the budgeting information via an email (block 518:EMAIL), then the transaction device may initiate creation of an email that includes the budgeting information (block 524), and the email may be sent to an email address associated with the user (block 526). The transaction device may initiate creation of the email by, e.g., submitting a request to the account management system, and a mail server at the account management system may create an email addressed to an email address of the user and that includes the budgeting information identified by the budget analysis module. If the user selects to receive the budgeting information via post mail (block 518:POST MAIL), then the transaction device may send a request to the account management system (block 528), and, in response to receipt of the request, post mail that includes the budgeting information identified by the budget analysis module may be generated and mailed to a mailing address associated with the user (block 530). If the user selects to receive the budgeting information via the account access portal (block 518:PORTAL), then a screen containing the budgeting information identified by the budget analysis module may be presented to the user via the account access portal the next time the user logs into the account management system via the account access portal (block 532). If the user selects to receive the budgeting information via a video chat session (block 518:VIDEO CHAT), then the transaction device may initiate a video chat with a remote teller (block 534), and the remote teller may provide the budgeting information to the user during the video chat session. In some example implementations, the transaction device may submit a request to the account management system to provide account, budget category, and transaction information with the remote teller (block 536) such that the remote teller may offer personalized budgeting information to the user during the video chat session.

Additional and alternative steps will be appreciated with the benefit of this disclosure. Budgeting information, for example, may be provided to the user in response to receipt of one or more selections of the user at the transaction device. The transaction device may present and the user may select one or more financial topics, budgeting topics, frequently-asked-questions, and so forth. In addition, instead of the user selecting a budget category, the user may initiate a video chat session with the remote teller during the transaction, and the remote teller may select a budget category on behalf of the user. Furthermore, instead of selecting a delivery channel for each transaction, the user may set a predefined delivery method using the budget management module via the account access portal. Other example implementations will be appreciated with the benefit of this disclosure.

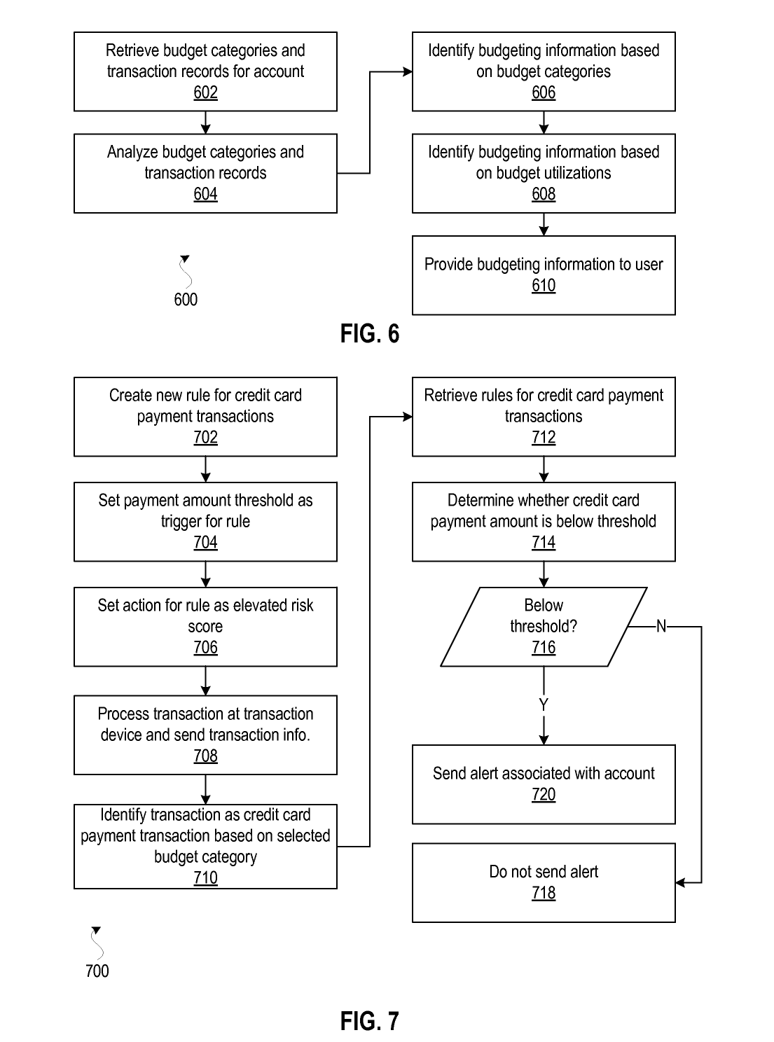

In FIG. 6, a flowchart 600 of example method steps for identifying budgeting information to present to a user is shown. The budget analysis module of an account management system may periodically retrieve for analysis the account records, budget category records, and transaction records associated with a user (block 602). The budget analysis module may additionally or alternatively initiate an analysis upon demand or in response to the occurrence of an event, e.g., the completion of a transaction at a transaction device. During the analysis, the budget analysis module may analyze the transaction records and associated budget categories (block 604) to, e.g., assess the budget utilizations of the budget categories. The budget analysis module may identify budgeting information to provide the user based on an analysis of the budget categories selected by the user (block 606) as described above. The budget analysis module may also identify budgeting information to provide the user based on an analysis of the budget utilizations of the budget categories (block 608) as also described above. Once identified, the budget analysis module may provide or initiate providing the budgeting information to the user (block 610).

As described above, the budget analysis module may also be configured to apply various rules defined for transaction-related events. In FIG. 7, a flowchart 700 of example method steps for applying a rule relating to credit card payment transactions is shown. A new rule for credit card payment transactions may be created (block 702). The trigger for the rule may be configured to be based on the payment amount of the credit card payment transaction (block 704), e.g., a payment amount threshold. In this example, the trigger may be configured to be satisfied when the payment amount of the credit card payment transaction is below the payment amount threshold set for the trigger. The action for the rule may be configured to initiate an alert associated with the account when the trigger is satisfied (block 706).

A transaction device may process a payment transaction and send the transaction information to a budget analysis module of an account management system (block 708). During the transaction, the user may have selected a “credit card” budget category to associate with the payment transaction, and the budget analysis module may identify the payment transaction as a credit card payment transaction based on the “credit card” budget category associated with the payment transaction (block 710). In response, the budget analysis module may retrieve one or more rules related to credit card payment transactions (block 712), such as the example rule described above regarding the payment amount threshold. The budget analysis module, in this example, may thus determine whether the payment amount of the credit card payment transaction is below the payment amount threshold set as the trigger for the rule (block 714). If the payment amount is not below the payment amount threshold (block 716:N), then the budget analysis module may not initiate the action defined for the rule, and the alert may not be sent (block 718) in this example. If, however, the payment amount is below the payment amount threshold set as the trigger for the rule (block 716:Y), then the trigger may be satisfied, the budget analysis module may initiate the action defined for the rule, and an alert for the account may be generated (block 720) in this example. It will be appreciated with the benefit of this disclosure that other rules may be implemented and applied in a similar fashion.

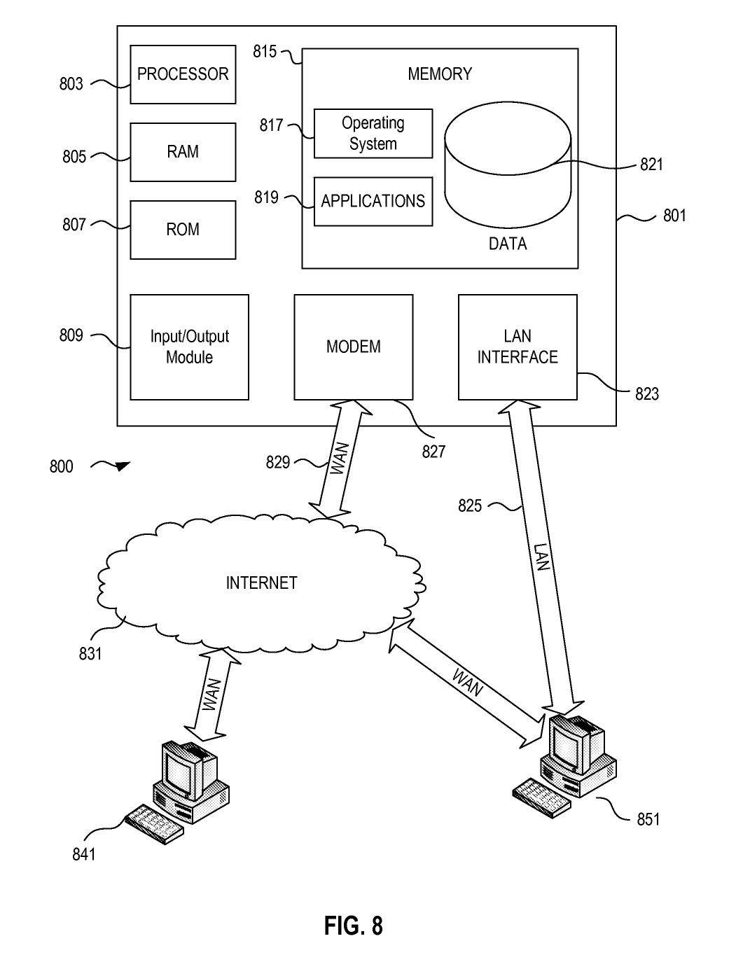

Referring to FIG. 8, a block diagram of an example operating environment in which various aspects of the disclosure may be implemented is shown. FIG. 8 illustrates a block diagram of at least a portion of a budgeting information system 801 (e.g., a computer server) in communication system 800 that may be used according to an illustrative embodiment of the disclosure. The system 801 may have a processor 803 for controlling overall operation of the system and its associated components, including RAM 805, ROM 807, input/output (I/O) module 809, and memory 815.

I/O 809 may include a microphone, keypad, touch screen, and/or stylus through which a user of the budgeting information system 801 may provide input, and may also include one or more of a speaker for providing audio output and a video display device for providing textual, audiovisual and/or graphical output. Software may be stored within memory 815 and/or storage to provide instructions to processor 803 for enabling the system 801 to perform various functions. For example, memory 815 may store software used by the system 801, such as an operating system 817, application programs 819, and an associated database 821. Processor 803 and its associated components may allow the system 801 to run a series of computer-readable instructions to facilitate associating budget categories with an account and with a transaction as well as analyze accounts, budget categories, and transactions.

The system 801 may operate in a networked environment supporting connections to one or more remote computers, such as terminals 841 and 851. The terminals 841 and 851 may be personal computers or servers that include many or all of the elements described above relative to the system 801. Alternatively, terminal 841 and/or 851 may be a data store that utilized by the system 801. The network connections depicted in FIG. 8 include a local area network (LAN) 825 and a wide area network (WAN) 829, but may also include other networks. When used in a LAN networking environment, the system 801 may be connected to the LAN 825 through a network interface or adapter 823. When used in a WAN networking environment, the system 801 may include a modem 827 or other means for establishing communications over the WAN 829, such as the Internet 831. It will be appreciated that the network connections shown are illustrative and other means of establishing a communications link between the computers may be used. Various well-known protocols such as TCP/IP, Ethernet, FTP, HTTP and the like may be used to establish connections and/or facilitate communications between elements of system 801 and various other computing devices.

Additionally, one or more application programs 819 used by the budgeting information system 801 according to an illustrative embodiment of the disclosure may include computer-executable instructions for providing budgeting information to individuals in accordance with various aspects described above.

The budgeting information system 801 and/or terminals 841 or 851 may also be mobile terminals, such as smart phones, personal digital assistants (PDAs), and the like, including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, and distributed computing environments that include any of the above systems or devices, and the like.

The disclosure may be described in the general context of computer-executable instructions, such as program modules, being executed by a computer. Generally, program modules include routines, programs, objects, components, data structures, and the like that perform particular tasks or implement particular abstract data types. The disclosure may also be practiced in distributed computing environments where tasks are performed by remote processing devices that are linked, for example, through a communications network. In a distributed computing environment, program modules may be located in both local and remote computer storage media including memory storage devices.

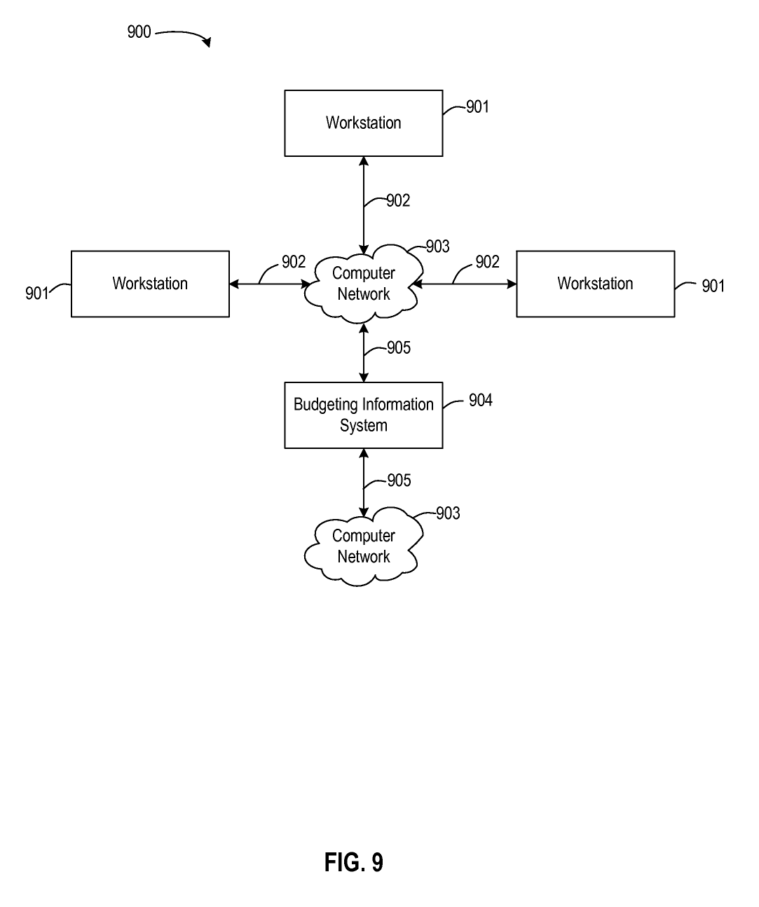

Referring to FIG. 9, is a block diagram of example workstations and servers that may be used to implement the processes and functions of one or more aspects of the present disclosure. In FIG. 9, an illustrative system 900 for implementing methods according to the present disclosure is shown. As illustrated, system 900 may include one or more workstations/servers 901. Workstations 901 may be local or remote, and are connected by one or more communications links 902 to computer network 903 that is linked via communications links 905 to the budgeting information system 904. In certain embodiments, workstations 901 may be different servers that communicate with the budgeting information system 904, or, in other embodiments, workstations 901 may be different points at which the budgeting information system 904 may be accessed. In system 900, the budgeting information system 904 may be any suitable server, processor, computer, or data processing device, or combination of the same.

Computer network 903 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 902 and 905 may be any communications links suitable for communicating between workstations 901 and the budgeting information system 904, such as network links, dial-up links, wireless links, hard-wired links, and the like.

The disclosure set forth above may be implemented by one or more of the components in FIG. 8 and FIG. 9 and/or other components, including other computing devices.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A method of providing budgeting support at a transaction device comprising:
initiating a transaction with a user at a transaction device;
receiving a plurality of budget categories associated with an account involved in the transaction;
presenting at least one of budget categories to the user at the transaction device during the transaction;
receiving input from the user that identifies one of the budget categories as a selected budget category; and
associating the selected budget category with a transaction record created for the transaction.

2. The method of claim 1 wherein the selected budget category is a selected source budget category and further comprising:
receiving input from the user that identifies one of the budget categories as a selected destination budget category; and
associating the selected destination budget category with the transaction record created for the transaction.

3. The method of claim 1 further comprising presenting a budget utilization associated with one of the budget categories at the transaction device.

4. The method of claim 3 wherein the budget utilization associated with the budget category comprises:
an estimated expenditure for the budget category; and
an actual expenditure for the budget category.

5. The method of claim 1 wherein the input received from the user is received after the user selects a transaction option and before the transaction is complete.

6. The method of claim 1 wherein the budgeting information is presented to the user at a display of the transaction device.

7. The method of claim 1 further comprising:
initiating a video chat session at the transaction device wherein the budgeting information is presented to the user during the video chat session.

8. An transaction device comprising:
a controller configured to conduct a transaction with a user;
a display;
an input interface; and
memory storing computer-readable instructions that, when executed by the controller,
cause retrieval of a plurality of budget categories associated with an account involved in the transaction,
cause the display to present the plurality of budget categories to the user during the transaction, and
cause one of the budget categories selected by the user via the input interface to be associated with a transaction record created for the transaction.

9. The transaction device of claim 8 wherein:
the transaction device is an automated teller machine (ATM); and
the transaction is one of a payment transaction, an transfer transaction, and a withdrawal transaction.

10. The transaction device of claim 8 wherein:
the transaction device is a point-of-sale device; and
the transaction is a purchase transaction.

11. The transaction device of claim 8 wherein:
the instructions, when executed by the controller, further cause budgeting information to be provided to the user;
the budgeting information is based, at least in part, on a budget utilization associated with one of the budget categories; and
the budgeting information is provide to the user via one or more of
an email sent to an email address associated with the user,
post mail sent to a mailing address associated with the user,
an account access portal through which the account of the user is accessible,
a receipt printed at a printer of the transaction device,
a screen presented at the display of the transaction device, and
combinations thereof.

12. The transaction device of claim 8 wherein:
the instructions, when executed by the controller, further
cause a video chat session to be initiated with a remote teller, and
cause the plurality of budget categories to be provided to the remote teller during the video chat session.

13. The transaction device of claim 8 wherein the transaction device is configured to create a new budget for the user and associate one or more budget categories with the new budget in response to input received from the user at the input interface.

14. A system for providing budgeting support during a transaction comprising:
a data store that stores an account record associated with a user and a plurality of budget category records;
an budget management module in signal communication with the data store and configured to, in operation, associate one or more of the budget category records with the account record responsive to receipt of input from the user;
a transaction device interface module in signal communication with the data store and configured to, in operation,
provide a transaction device with information identifying one or more budget category records associated with the account record during a transaction at the transaction device,
receive, from the transaction device, information indicating a selected budget category record selected by the user at the transaction device during the transaction, and
cause the selected budget category record to be associated with a transaction record created for the transaction.

15. The system of claim 14 wherein:
at least one of the budget category records is a predefined budget category record; and
at least one of the budget category records is a user-defined budget category record.

16. The system of claim 14 further comprising a budget analysis module configured to, in operation,
analyze a set of budget category records associated with an account record of the user,
analyze a set of transaction records associated with the account record, and
identify budgeting information to provide the user based on an analysis of at least one of the set of budget category records, the set of transaction records, and combinations thereof.

17. The system of claim 16 wherein:
the budgeting information identified by the budget analysis module is based on one or more of the budget category records associated with the account of the user.

18. The system of claim 16 wherein:
the budgeting information identified by the budget analysis module is based on a budget utilization of one of the budget category records associated with the account record of the user; and
the budget utilization comprises an estimated expenditure of the budget category record and an actual expenditure of the budget category record.

19. The system of claim 16 wherein the budget analysis module is further configured to apply a rule during the transaction, determine whether a trigger defined for the rule is satisfied, and initiate performance of an action defined for the rule responsive to a determination that the trigger is satisfied.

20. The system of claim 19 wherein:
the trigger defined for the rule involves a comparison between a payment amount associated with the transaction and payment amount threshold, and
the action defined for the rule causes an alert associated with the account record to be sent when the trigger for the rule is satisfied.
